(19) United States
(12) Patent Application Publication
(10) Pub. No.: US 2016/0180282 A1
(43) Pub. Date: Jun. 23, 2016

(54) SYSTEMS AND METHODS FOR CROWDFUNDING AND CROWDSOURCING A PROJECT

(71) Applicant: UMM AL-QURA UNIVERSITY, Makkah (SA)

(72) Inventors: Anas BASALAMAH, Makkah (SA); Saleh Basalamah, Makkah (SA); Mostafa Elganainy, Makkah (SA)

(73) Assignee: UMM AL-QURA UNIVERSITY, Makkah (SA)

(21) Appl. No.: 14/975,203

(22) Filed: Dec. 18, 2015

Related U.S. Application Data
(60) Provisional application No. 62/093,892, filed on Dec. 18, 2014.

(51) Int. Cl. G06Q 10/06; G06Q 30/02; G06Q 50/00; G06Q 20/10

(52) U.S. Cl. CPC G06Q 10/063118; G06Q 20/10; G06Q 30/0279; G06Q 50/01

(57) ABSTRACT

A system and method for crowdfunding and crowdsourcing a project that receives, via communication circuitry, a project from a user, determines, using processing circuitry, whether the project adheres to a predetermined criteria, provides the project to a crowdsourcing community and a crowdfunding community, receives bids from one or more freelancers to implement one or more parts of the project, receives contributions from one or more contributors, selects at least one freelancer based on a predefined rule, determines a total amount of contributions, determines a total amount of funds needed, determines whether the total amount of contributions is at least equal to the total amount of funds needed, assigns the one or more parts of the project to the selected at least one freelancer, transmits an alert to at least on device associated with the selected at least one freelancer, and submits payments to the selected at least one freelancer.

### CROSS-REFERENCE TO RELATED APPLICATIONS

This application claims the benefit of priority from U.S. Provisional Application No. 62/093,892 filed Dec. 18, 2014, the entire contents of which are incorporated herein by reference.

### BACKGROUND

Crowdfunding is the practice of funding a project or venture by raising monetary contributions from a large number of people, typically via the internet. The crowdffinding model is fueled by three types of actors: a project initiator who proposes the idea and/or project to be funded; individuals or groups who support the idea; and a moderating organization that brings the parties together to launch the idea. In 2013, the crowdfunding industry grew to over 5.1 billion worldwide. Examples of crowdfunding platforms include Kickstarter.com and Indiegogo.com.

The foregoing “background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present disclosure. The foregoing paragraphs have been provided by way of general introduction, and are not intended to limit the scope of the following claims. The described embodiments, together with further advantages, will be best understood by reference to the following detailed description taken in conjunction with the accompanying drawings.

### SUMMARY

The present disclosure relates to a crowdfunding and crowdsourcing system and associated methodology that receives, via communication circuitry, a project from a user, determines, using processing circuitry, whether the project adheres to a predetermined criteria, provides, via the communication circuitry, the project to a crowdsourcing community and a crowdfunding community when the project adheres to the predetermined criteria, receives, via the communication circuitry, bids from one or more freelancers associated with the crowdsourcing community to implement one or more parts of the project, receives, via the communication circuitry, contributions from one or more contributors associated with the crowdfunding community, selects, using the processing circuitry, at least one freelancer based on a predefined rule, determines, using the processing circuitry, a total amount of contributions based on the received contributions from the one or more contributors, determines, using the processing circuitry, a total amount of funds needed based on a bid of the selected at least one freelancer, determines, using the processing circuitry, whether the total amount of contributions is at least equal to the total amount of funds needed, assigns, using the processing circuitry, the one or more parts of the project to the selected at least one freelancer when the total amount of contributions is a least equal to the total amount of funds needed, transmits, via the communication circuitry, an alert to at least one device associated with the selected at least one freelancer, wherein the alert causes a message to display on the selected at least one freelancer device, and submits, via the communication circuitry, payments to the selected at least one freelancer when the one or more corresponding parts associated with the selected at least one freelancer is approved.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an exemplary schematic of a system for crowdfunding and crowdsourcing a project according to one example;

FIG. 2 is a schematic of a user profile according to one example;

FIG. 3 is a flow chart showing a method for crowdfunding and crowdsourcing a project according to one example;

FIG. 4 is an exemplary flow chart for selecting a freelancer according to one example;

FIG. 5 is an exemplary table that shows ratings of freelancers according to one example;

FIG. 6 is an exemplary table that shows weights for factors to select a freelancer according to one example;

FIG. 7 is an exemplary flow chart for crowdfunding and crowdsourcing a project according to one example;

FIG. 8 is an exemplary user interface of a user device using the method for crowdfunding and crowdsourcing according to one example;

FIG. 9 is an exemplary block diagram of a server according to one example;

FIG. 10 is an exemplary block diagram of a data processing system according to one example; and

FIG. 11 is an exemplary block diagram of a central processing unit according to one example.

### DETAILED DESCRIPTION

Referring now to the drawings, wherein like reference numerals designate identical or corresponding parts throughout several views, the following description relates to a crowdfunding and crowdsourcing system and associated methodology for accepting and implementing a project through crowdfunding and crowdsourcing simultaneously. Crowdfunding is a form of investment that has the ability to tap into a large number of investors for smaller amounts of money per investor. A crowdfunding platform can be a website designed to bring entrepreneurs, startup companies, and individuals seeking funding with investors.

Current systems for crowdfunding assume that a project initiator has the necessary skills and capability to develop the project. Individuals or groups evaluate and fund the project accordingly. When a person is not capable to do the project himself, current crowdfunding platforms will not support the project.

The system and associated methodology of the present disclosure provides a reliable method and platform for crowdfunding ideas that are implemented by a community of competing freelancers rather than the project initiator.

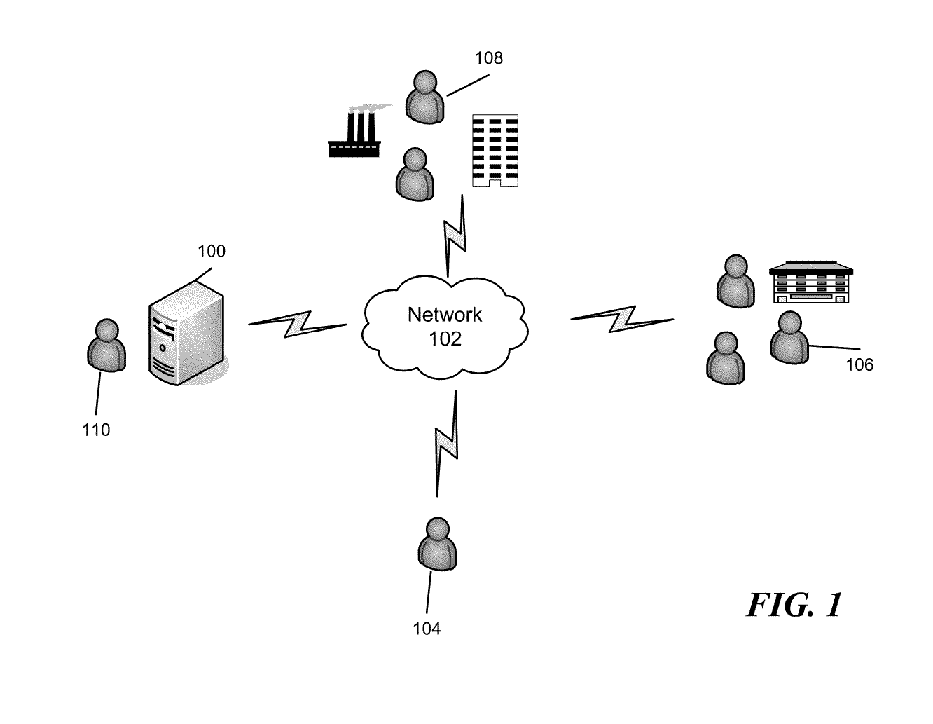

FIG. 1 is an exemplary schematic of a system for crowdfunding and crowdsourcing a project according to one example. A project initiator 104 sends an idea of a project to a server 100 via a network 102. The project initiator 104 may be an individual, a start-up company, or the like. The server 100 is managed by a moderating organization 110. The project may include detailed specifications and requirements. The project initiator 104 may also send to the server 100 a presentation containing videos and animations to illustrate the idea. The moderating organization 110 then publishes the project to a community through the network 102. The moderating organization 110 may publish the project on a website. The community may include a crowdsourcing community and crowdfunding community. The crowdsourcing community may include a plurality of freelancers. FIG. 1 shows a freelancer 108 and a contributor 106. The crowdfunding community may include a plurality of contributors. The funding community 106 may include individuals, financial institutions such as banks, investment companies, and the like (collectively referred to herein as contributors). A freelancer 108 may be an individual with qualification to implement the project, a factory, a company or the like. The network 102 is any network that allows the moderating organization 110, the project initiator 104, the freelancer 108 and the contributor 106 to communicate information with each other such as a Wide Area Network, Local Area Network or the internet.

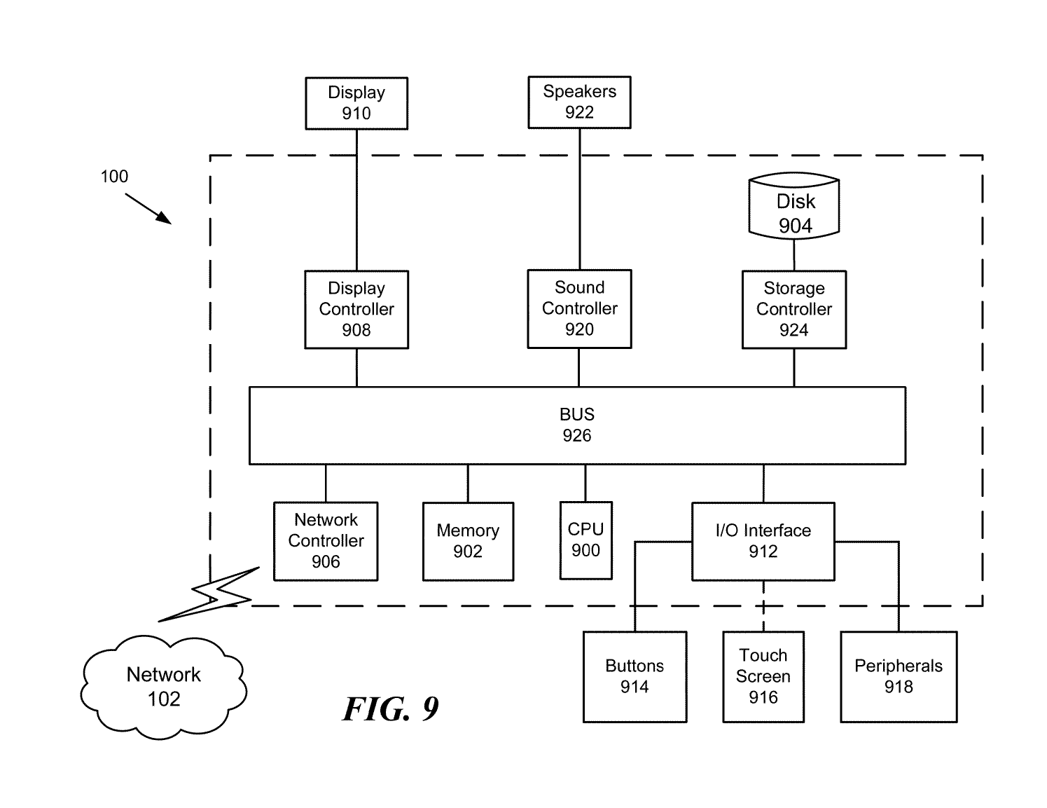

In one embodiment, the server 100 provides a webpage to the project initiator 104, the moderating organization 110, the freelancer 108, and the contributor 106. The server 100 may provide for each of the freelancer 108, the contributor 106, and the project initiator 104 a specific interface. The specific interface may include control elements. For example, the control elements for the freelancer interface may include fields for inputting a plan and a monetary amount. The project initiator 104 interacts with the server 100 via a user device. The user device includes a mobile telephone, a computer, a laptop, a smart phone, a tablet PC, or the like. The server 100 includes a CPU 900, a memory 902, and a network controller 906, as shown in FIG. 9.

The network 102 may include the Internet or any other network capable of communicating data between devices. Suitable networks can include or interface with any one or more of a local intranet, a PAN (Personal Area Network), a LAN (Local Area Network), a WAN (Wide Area Network), a MAN (Metropolitan Area Network), a VPN (Virtual Private Network), or a SAN (storage area network). Furthermore, communications may also include links to any of a variety of wireless networks, including WAP (Wireless Application Protocol), GPRS (General Packet Radio Service), GSM (Global system for Mobile Communication), CDMA (Code Division Multiple Access) or TDMA (Time Division Multiple Access), cellular phone networks, GPS (Global Positioning System), CDPD (Cellular digit packet data), Bluetooth radio, or an IEEE 802.11 based radio frequency.

In one embodiment, the server 100 may store data associated with each freelancer, contributor and project initiator. Additionally, the server 100 may store data associated with terms, finances, fulfillment, and assets related to various transactions. The server 100 can host documents, spreadsheets, presentations, HTML files, CSS files, JavaScript code, images, or other resources needed to render a page.

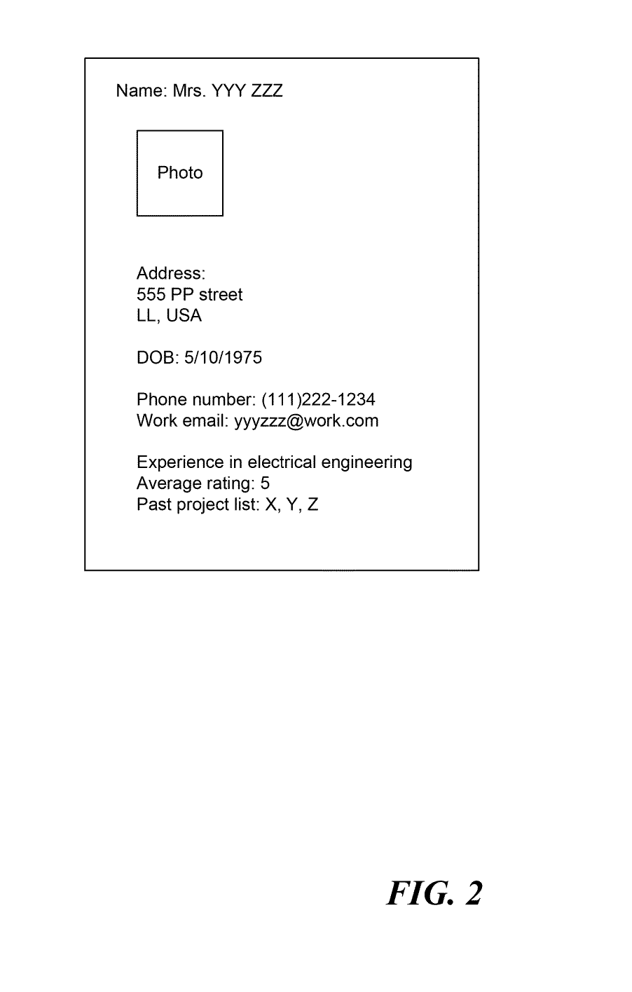

FIG. 2 shows a user profile according to one example. The user profile may be stored in the memory 902 and/or in a user profile database. The database may also store a type associated with the user such as contributor, freelancer or project initiator. The user profile may include one or more of, but not limited to, a name, a photo, and an identification number. In FIG. 2, the user profile includes at least one of a name, a photo, an address, a date of birth, contact information, a summary of experience, an average rating, and a project list. The profile shown in FIG. 2 corresponds to a freelancer.

In selected embodiments, each user may be required to register. The user may be the project initiator 104, the freelancer 108, or the contributor 106. The user may input a name, an email address, a password, a country of residence, a phone number, and a mailing address. The registration may also include other identifying information such as a social security number. Once registered, the user may post a project, submit a bid, and/or submit contributions. To collect registration information from the user, the server 100 may provide the user with a webpage containing text and numerical fields for the user to fill in. Information provided by the user is then stored in the memory 902.

The freelancer may connect to the server 100 via the network 102 to determine a suitable project. The freelancer may search or filter through the various projects. In one embodiment, the CPU 900 determines a suitable freelancer for a particular project (idea) based on the freelancer's qualification. The CPU 900 may use the freelancer's profile stored in the memory 902 to match the project with a freelancer.

The contributor 106 may connect to the server 100 to find a suitable project to invest in it. In one embodiment, the CPU 900 may compare each of the funding community interest with the project to find suitable contributors. Then, the CPU 900 may send requests for contributions when a match is found. In addition, the contributor 106 may set a funding limit. For example, the contributor 106 may set a predetermined number of projects per period or a total amount of contributions per period. The CPU 900 checks to see whether the contributor has exceeded the funding limit by comparing the funding limit stored in the memory 902 with a contributor log that stores the total funding for each contributor. The CPU 900 sends projects to contributors that did not exceed their funding limit.

In one embodiment, the project initiator 108 may query the server 100 to receive an update about the project status. For example, the project initiator 108 may check the number of contributions and bids received.

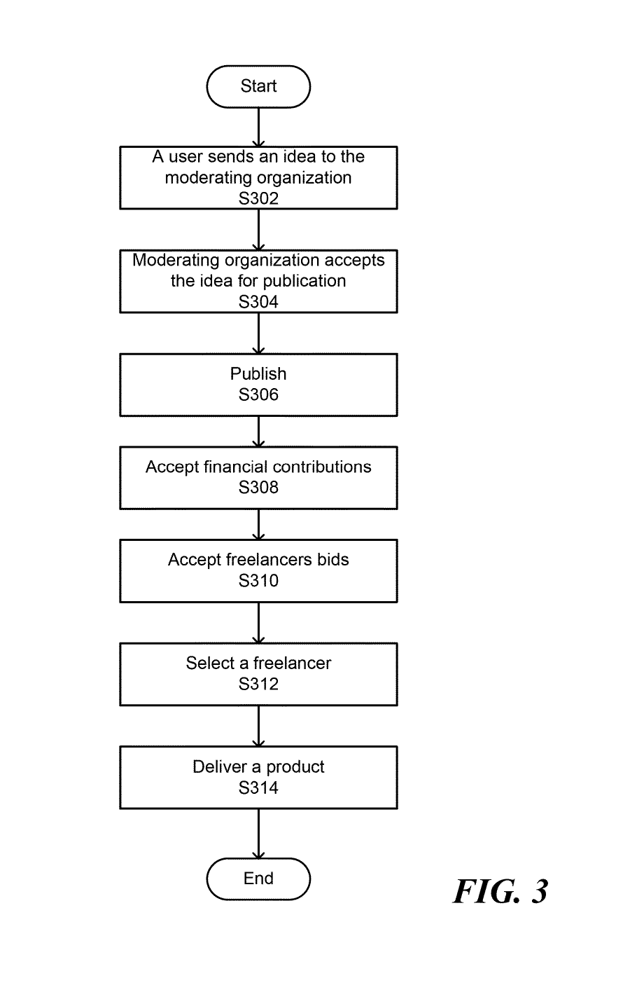

FIG. 3 is a flow chart showing a method for crowdfunding and crowdsourcing a project according to one example. At step S302, the server 100 may receive the idea of the project from the project initiator 104 via the network 102. The data may include a project title, a brief description, a detailed description, drawings, or the like. In one embodiment, the server 100 may authenticate the user using a communication interface.

At step S304, the moderating organization may review the idea. The moderating organization 110 may reject the idea. For example, the moderating organization 110 may reject the idea in response to determining that the idea does not confirm with preset standards. The preset standards may include a requirement of a detailed description of the project. The preset standard may be stored in the memory 902. In one embodiment, the CPU 900 may automatically check to see whether the received idea meets the preset standards. For example, the CPU 900 may use text matching techniques as would be understood by one of ordinary skill in the art, to determine whether the received idea meets the preset standards. For example, the CPU 900 may compare a word number limit and a language of the detailed description with the preset standards.

At step S306, the project is published. The project may be published online through a website hosted on the server 100. The website may also be hosted by a third party provider. In one embodiment, the project may be published by a third party. For example, the third party may be other freelancing or crowdfunding websites. The project initiator 104 may advertise the idea on social media such as Facebook and twitter. The project initiator 104 may also set a deadline for bid acceptance.

At step S308, the moderating organization 110 using the CPU 900 may start accepting contributions from the funding community.

At step S310, the moderating organization 110 may start accepting bids and proposals from freelancers. In other embodiments, the moderating organization 110 may start accepting bids and proposals before starting accepting contributions. The freelancers may send proposals to implement one or more parts of the project. In selected embodiments, freelancers may be allowed to see each other's bids. The freelancers may be allowed to change their bids amount. This has the advantage to get good market rates. The CPU 900 may determine whether all the parts of a project have received bids. In response to determining that one or more parts did not receive bids from freelancers, the CPU 900 may generate alerts to registered freelancers that indicate the one or more parts that did not receive bids. The server 100 receives proposals from the freelancers. Each proposal may include at least one of a detailed plan to develop the idea, an amount of money that they would like to earn, an amount of money required from contributors, and any previous related work. The proposal may include videos and presentations. The server 100 may receive inputs from the community that include feedback about the idea. The server 100 may publish the inputs on the website.

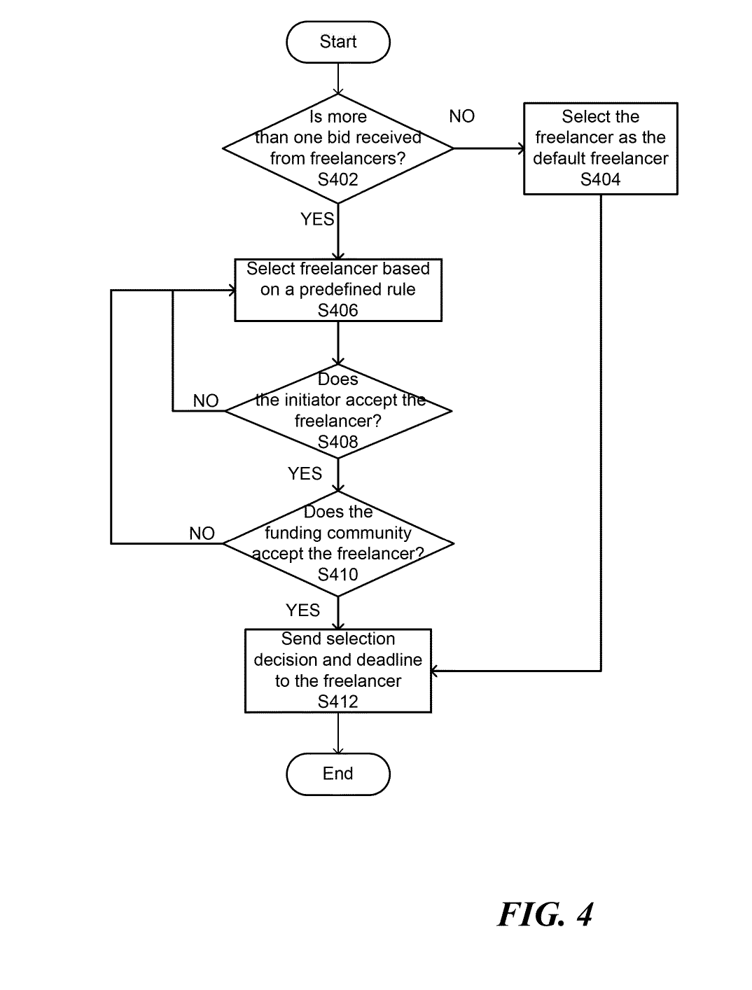

At step S312, a freelancer may be selected by the CPU 900 based on a predefined rule. The predefined rule is a function of a plurality of factors and criteria. The freelancer may be selected when a deadline or a bid amount is achieved. A method for selecting a freelancer is shown in FIG. 4. The CPU 900 may check to see whether all the parts of the project have received bids from at least one freelancer before selecting one or more freelancers to implement the project.

The CPU 900 may calculate a total amount of contributions based on the received contributions from the crowdfunding community. In addition, the CPU 900 may calculate a total amount of funds needed based on the bids of the selected one or more freelancers. Then the CPU 900 compares the total amount of contributions with the total amount of funds needed. In response to determining that the total amount of contributions is at least equal to the total amount of funds needed, the CPU 900 assigns the one or more parts of the project to freelancers selected via the methodology described in FIG. 4. As described in FIG. 4, the freelancer may be selected based on user ratings, experience, years in business, or the like.

At step S314, a product based on the project (idea) is delivered. In selected embodiments, the freelancer is paid by the moderating organization 110 when the project is complete. In one embodiment, the CPU 900 submits payments to the selected one or more freelancers when the server 100 receives an approval from the project initiator 104. In other embodiments, the project initiator 104 and the contributors 106 need to approve the project before payments are sent to the selected one or more freelancers. The projector initiator 104 and the funding community 106 may evaluate the freelancer 108 based on the delivered product. For example, the server 100 may receive a rating from each of the project initiator 104 and the funding community that indicates a satisfaction with the project. The CPU 900 computes an average rating. The average rating is stored in the memory 902 and is associated with the freelancer profile.

The methods described herein may be performed by logic that may comprise hardware (e.g., dedicated logic, programmable logic, and microcode), software (such as software run on a general-purpose computer system or a dedication machine), or a combination of both. In one example, the logic is included in the server 100.

FIG. 4 is an exemplary flowchart for selecting a freelancer according to one example that corresponds to step S312 of FIG. 3. At step S312, the server 100 may use the method described herein to select the freelancer. At step S402, the CPU 900 may check to see whether more than one bid is received to implement one or more parts of the project. A bid may represent an offer from a freelancer to execute one or more parts of the project (idea). In response to determining that only one bid is received, the CPU 900 selects the freelancer associated with the only bid at step S404 or provides an option not to proceed. In response to determining that more than one bid is received, a freelancer is selected based on a predefined rule at step S406 by the CPU 900.

The predefined rule can be a function of one or more factors. For example, the freelancer with the highest rating may be selected. In other embodiments, the funding community may vote on each proposal from freelancers. Then, the CPU 900 computes the number of vote for each proposal (bid). The bid with the highest number of votes may be selected. When the project is divided into one or more parts, the CPU 900 computes the number of votes for each part separately. The CPU 900 selects the freelancer that has the highest number of votes for each part.

In selected embodiments, the freelancer may need a predetermined amount of votes to be selected. That is, the CPU 900 compares the number of votes received with the predetermined amount of votes, when the number of votes is less than the predetermined amount of votes, the freelancer is not selected. In one embodiment, the CPU 900 may extend the voting and bids submittal period until a freelancer receives the predetermined number of votes.

In selected embodiments, the CPU 900 may select the freelancer based on a freelancer rating. The CPU 900 may determine the rating of each freelancer from past projects. In one embodiment, the rating is computed only using data for a predetermined period or for a predetermined number of projects. For example, the CPU 900 may compute the rating of the freelancer based on the last 10 projects. The CPU 900 may also compute an average rating using ratings received during the last month. In addition, in selected embodiments, the CPU 900 may only determine the rating based on past projects that have the same category as the current project.

In selected embodiments, the freelancer associated with the lowest bid is selected by the CPU 900. The bids received by the server 100 may be in different currencies. Thus, the CPU 900 may convert all bids received to a predefined currency before selecting the lowest bid. In addition, the server 100 may connect via the network 102 to other servers to obtain updated exchange rates. The freelancers may also submit the bids using different billing methods such as per part, per hour or per project. Thus, the CPU 900 may convert the bids to a common billing method before selecting the lowest bid.

In selected embodiments, a weighted formula may be used to select the freelancer based on the plurality of factors described herein or other factors. The weight of each factor may be set by the project initiator 104 or the moderating organization 110. The weighted formula may be expressed as:

$$Rank = {\sum }_{i = 1}^{n} {factor}_{i} \times {weight}_{i} \qquad ( 1 )$$

where n is the number of factors. The CPU 900 may calculate a rank for each freelancer using equation (1). A first factor may represent a geographic location and have a weight of 0.2. For example, the first factor may be a distance from the freelancer to the project initiator 104. A second factor may represent the rating of each freelancer and have a weight of 0.8. The freelancer with the highest rank is selected by the CPU 900.

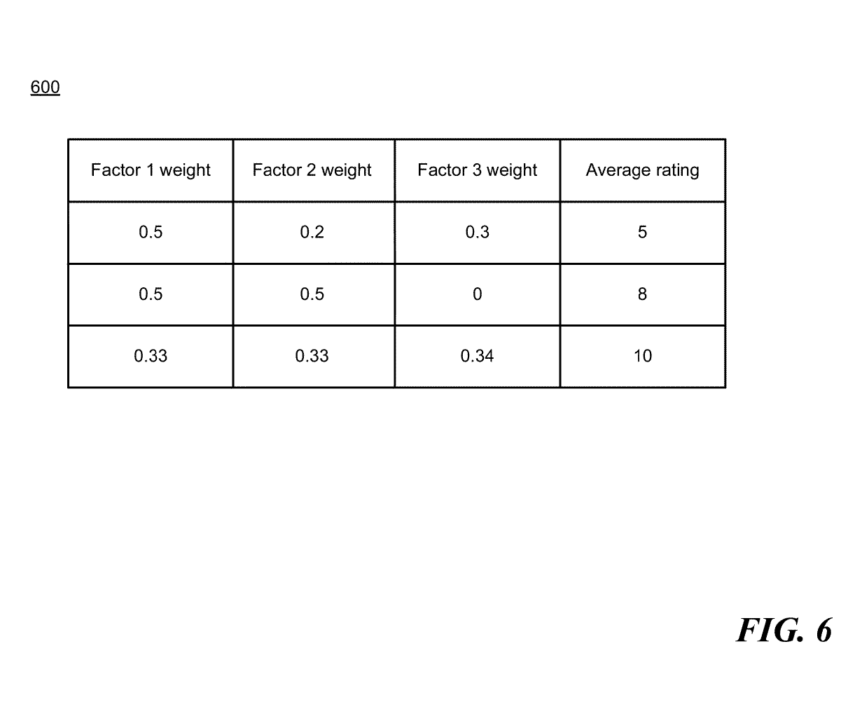

In one embodiment, the weight of each factor is computed by the CPU 900 based on past data. That is, for each project the weight of each factor is stored in the memory 902 with the rating given by the project initiator and/or the funding community. The combination of weights that has the highest success rate is used by the CPU 900 for selecting a freelancer of a new project. For example, the CPU 900 may use a look-up table to determine the weights. The look-up table includes the weight of each factor and the average rating computed by the CPU 900. An exemplary look-up table is shown in FIG. 6. The CPU 900 determines the highest average rating and uses the associated weight to select the freelancer. Using table 600, the CPU 900 determines that setting the weight of factor 1 to 0.33, the weight of factor 2 to 0.33, and the weight of factor 3 to 0.34 gives the highest average rating. In selected embodiments, the weights can be manually set based on what is important to the user.

The plurality of factors may include geographic location. For example, freelancers or contributors may be restricted to a plurality of countries. The geographic location of the freelancer may be determined by a plurality of methods. For example, the geographic location may be stored in the user profile. The geographic location may also correspond with the user device. That is, once the user device's location is determined by any of the techniques described herein or other methods as known in the art, the user's location is also likely established. The user device's location can be determined via various satellite-based positioning systems known in the art, such as GPS (Global Positioning System). For example, the user device may include a location detector. The location detector may be a GPS module for detecting a current geographical location of the user device. In one embodiment, the user device's location is determined via a cellular tower with which communication has been established using current technology such as GMS (Global System for Mobile) localization, triangulation, Bluetooth, hotspots, WiFi detection, or other methods as would be understood by one of ordinary skill in the art. In one embodiment, the user device's location is determined by the network 102. In particular, the CPU 900 may detect a location of the user device as a network address on the network 102. The CPU 900 may also store the location in the memory 902.

The server 100 may receive a response indicating whether the project initiator accepts the selected freelancer. At step S408, the server 100 may analyze the response to determine whether the project initiator accepts the selected freelancer. In response to determining that the project initiator accepts the selected freelancer, the flow goes to step S410. In response to determining that the project initiator does not accept the selected freelancer, the flow goes to step S406.

At step S410, the CPU 900 may check whether the funding community accepts the freelancer. In response to determining that the funding community does not accept the freelancer, the process goes back to step S406 and another freelancer is selected. In response to determining that the funding community accepts the freelancer then the flow goes to step S412.

At step S412, a notification is generated and sent to the selected freelancer by the CPU 900. The notification may also include a deadline by which the work should be completed.

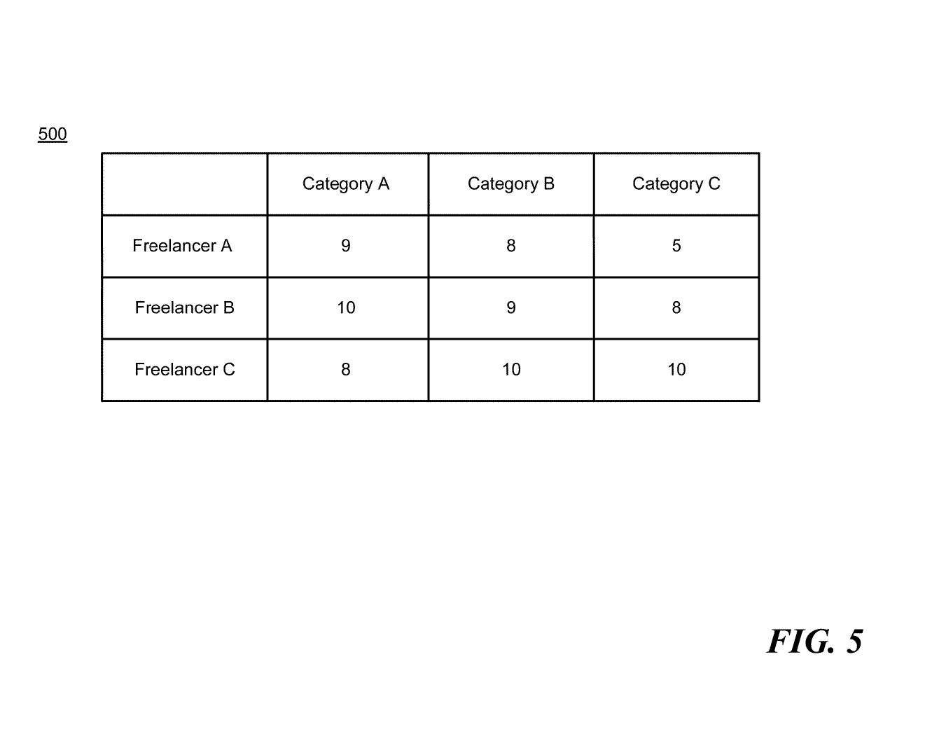

FIG. 5 is an exemplary table that shows ratings of freelancers according to one example. The rating for each freelancer in each category may be stored separately. Table 500 shows exemplary ratings for three freelancers in three categories. Table 500 may be used by the CPU 900 to determine the freelancer with the highest rating in the category that matches the category of the project. The category of the project may include, but is not limited to, engineering, writing, translation, web development or the like. As shown in Table 500, freelancer B has a higher rating in category A than freelancer C while freelancer C has a higher rating than freelancer B in category B. Thus, if the project is in category A, the CPU 900 selects freelancer B.

FIG. 6 is an exemplary table that shows weights for factors to select a freelancer according to one example. As explained above, the CPU 900 stores in the memory 902 the rating of the project with the weights used to select the freelancers. Table 600 shows an exemplary log stored in the memory 902 that shows the weights of each factors and the rating of the project.

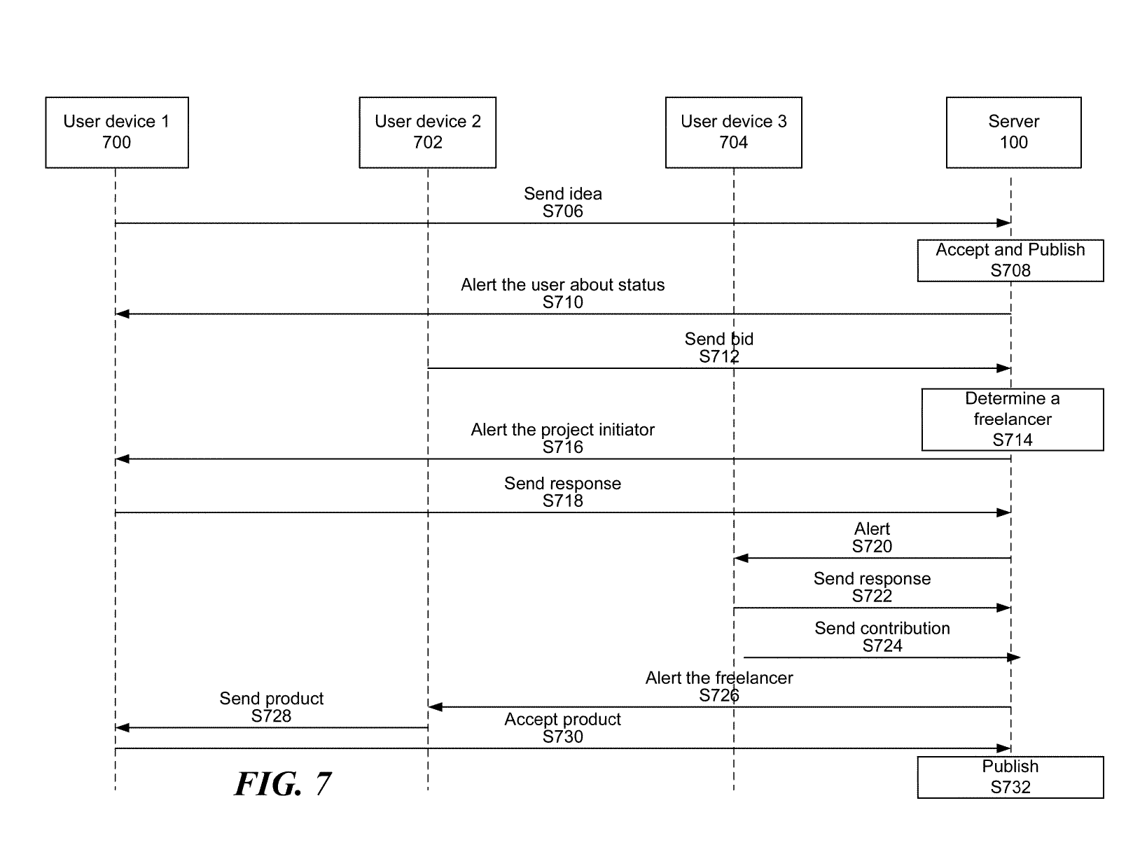

FIG. 7 is an exemplary flow chart for crowdfunding and crowdsourcing a project according to one example. The project initiator 104 may use a first user device 700. The freelancer 108 may use a second user device 702. The contributor 106 may use a third user device 704 to connect to the server 100. At step S706, the project initiator 104 sends the project description to the server 100. At step S708, the server 100 using the CPU 900 validates and publishes the project. At step S710, the CPU 900 generates a message to the project initiator 104 indicating the status of the project. For example, the generated message may indicate that the project has been accepted and published by the server. At 5712, the freelancer sends a bid to the server 100. As explained above the above may indicate the momentary value needed for completion of one or more parts of the project. The server 100 receives a plurality of bids. At step S714, the CPU 900 may select a freelancer. At step S716, the CPU 900 generates an alert to the projector initiator indicating the selected freelancer. The project initiator may then send a response accepting or rejecting the selected freelancer at step S718. At 5720, the CPU 900 generates an alert for the funding community indicating the selected freelancer. At step S722, each member of the funding community may send a response to the server 100 accepting or rejecting the selected freelancer. At step S724, each member of the funding community may send a contribution to the server 100. At step S729, the server 100 generates a third alert to the freelancer 108 indicating whether he was selected. The freelancer then sends the product to the project initiator at step S728. The projector initiator 104 then sends a message to the server 100 indicating the acceptance of the project. At step S732, the CPU 900 may publish the project. The CPU 900 may also send a payment to the freelancer.

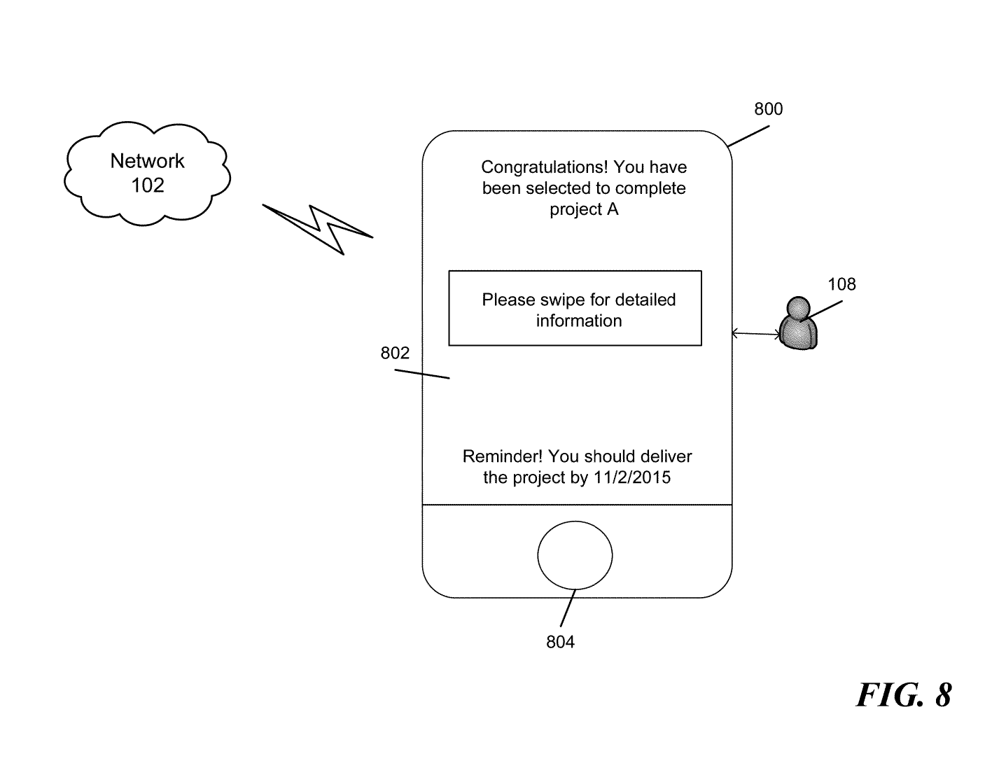

FIG. 8 is an exemplary user interface of a user device using the method for crowdfunding and crowdsourcing according to one example. The freelancer 108 may interact with the server 100 via a mobile device 800. In one example, the mobile device may include a touchscreen 802 and a button 804. The mobile device 800 may be, for example, a tablet, a personal digital assistant, a cellular telephone or a smart phone. The CPU 900 may generate an alert to the selected one or more freelancers.

In one embodiment, the CPU 900 may provide users with an application for installation on the mobile device. The mobile device 800 may automatically activate the application and display an alert received in response to receiving the alert from the server 100 via the network 102. A user interaction with the alert may be received through the touchscreen 802 or the button 804. Processing the user interaction may include dismissing the alert, accepting or following the instructions displayed on the touchscreen 802. Alerting the freelancer 108 automatically via the mobile device 800 once a selection is made at step S412 has the advantage of providing timely project delivery. This solves the problem of any human interaction, which could create delays and negatively impact the project. Also, it prevents the freelancer 108 from starting working on other projects which resolves issues with the organization of projects and timely completeness of them. In addition, the freelancer 108 does not need to login to a website to check a status of a bid as the alert is automatically displayed on the touchscreen. In addition, an alert may be transmitted to a device associated with the project initiator 104, to indicate that the project has been completed by the freelancers. Accordingly, the methodology described herein could not be implemented by a human due to the sheer complexity of data, calculating and organization. Further, the automatic activation of the application resolves issues with timeliness, which could otherwise be introduced by a human counterpart.

FIG. 9 is an exemplary block diagram of the server 100 according to one embodiment. In FIG. 9, the server includes a CPU 900 which performs the processes described above as well as those described herein in this application in combination or alone. The process data and instructions may be stored in memory 902. These processes and instructions may also be stored on a storage medium disk 904 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the mobile device communicates, such as a server or computer.

Further, the claimed advancements may be provided as a utility application, background daemon, or component of an operating system, or combination thereof, executing in conjunction with CPU 900 and an operating system such as Microsoft Windows 7, UNIX, Solaris, LINUX, Apple MAC-OS and other systems known to those skilled in the art.

CPU 900 may be a Xenon or Core processor from Intel of America or an Opteron processor from AMD of America, or may be other processor types that would be recognized by one of ordinary skill in the art. Alternatively, the CPU 900 may be implemented on an FPGA, ASIC, PLD or using discrete logic circuits, as one of ordinary skill in the art would recognize. Further, CPU 900 may be implemented as multiple processors cooperatively working in parallel to perform the instructions of the inventive processes described above.

The server in FIG. 9 also includes a network controller 906, such as an Intel Ethernet PRO network interface card from Intel Corporation of America, for interfacing with network 102. As can be appreciated, the network 102 can be a public network, such as the Internet, or a private network such as an LAN or WAN network, or any combination thereof and can also include PSTN or ISDN sub-networks. The network 102 can also be wireless such as a cellular network including EDGE, 3G and 4G wireless cellular systems. The wireless network can also be WiFi, Bluetooth, or any other wireless form of communication that is known.

The server further includes a display controller 908, such as a NVIDIA GeForce GTX or Quadro graphics adaptor from NVIDIA Corporation of America for interfacing with display 910, such as a Hewlett Packard HPL2445w LCD monitor. A general purpose I/O interface 912 interfaces with a keyboard and/or mouse 914 as well as a touch screen panel 916 on or separate from display 910. General purpose I/O interface also connects to a variety of peripherals 918 including printers and scanners, such as an OfficeJet or DeskJet from Hewlett Packard.

A sound controller 920 is also provided in server, such as Sound Blaster X-Fi Titanium from Creative, to interface with speakers/microphone 922 thereby providing sounds and/or music.

The general purpose storage controller 924 connects the storage medium disk 904 with communication bus 926, which may be an ISA, EISA, VESA, PCI, or similar, for interconnecting all of the components of the mobile device. A description of the general features and functionality of the display 910, keyboard and/or mouse 914, as well as the display controller 908, storage controller 924, network controller 906, sound controller 920, and general purpose I/O interface 912 is omitted herein for brevity as these features are known.

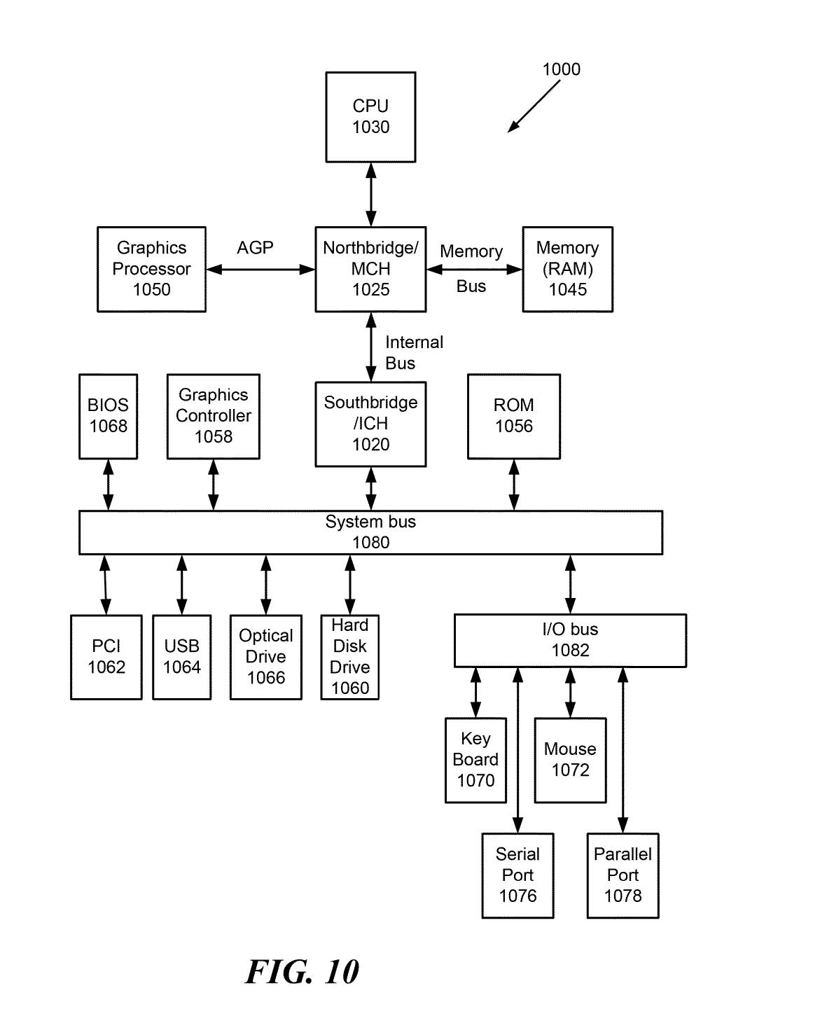

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in the circuitry on a single chipset, as shown on FIG. 10.

FIG. 10 shows a schematic diagram of a data processing system, according to certain embodiments, for crowdsourcing and crowdfunding a project. The data processing system is an example of a computer in which specific code or instructions implementing the processes of the illustrative embodiments may be located to create a particular machine for implementing the above-noted process.

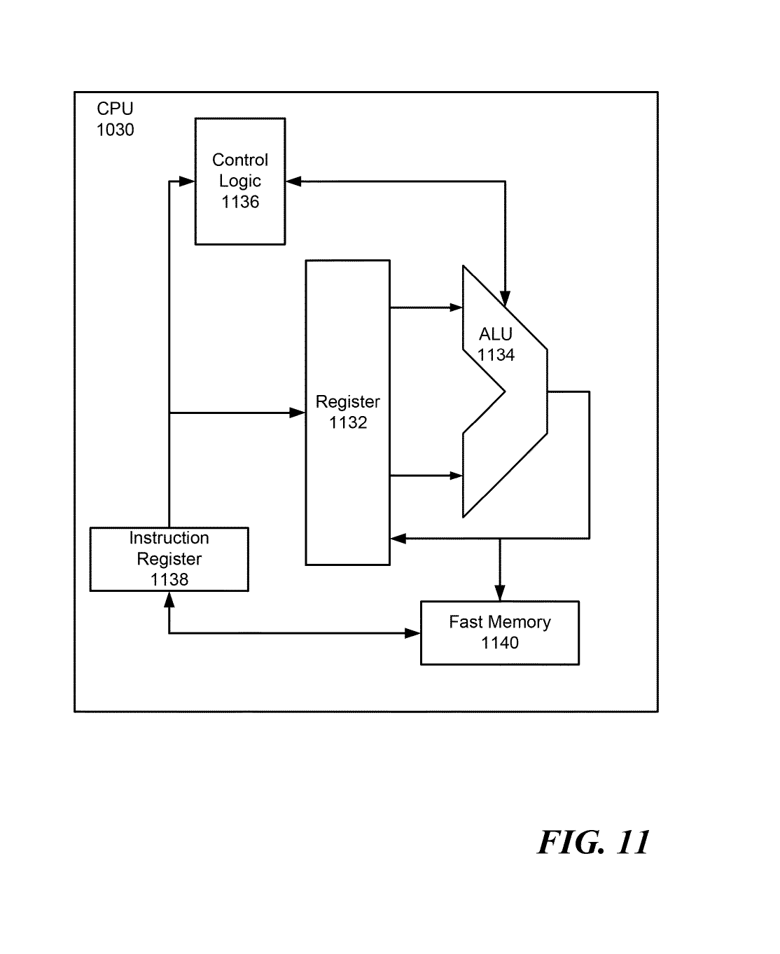

In FIG. 10, data processing system 1000 employs a hub architecture including a north bridge and memory controller hub (NB/MCH) 1025 and a south bridge and input/output (I/O) controller hub (SB/ICH) 1020. The central processing unit (CPU) 1030 is connected to NB/MCH 1025. The NB/MCH 1025 also connects to the memory 1045 via a memory bus, and connects to the graphics processor 1050 via an accelerated graphics port (AGP). The NB/MCH 1025 also connects to the SB/ICH 1020 via an internal bus (e.g., a unified media interface or a direct media interface). The CPU Processing unit 1030 may contain one or more processors and may even be implemented using one or more heterogeneous processor systems. For example, FIG. 11 shows one implementation of CPU 1030.

Further, in the data processing system 1000 of FIG. 10, SB/ICH 1020 is coupled through a system bus 1080 to an I/O Bus 1082, a read only memory (ROM) 1056, an universal serial bus (USB) port 1064, a flash binary input/output system (BIOS) 1068, and a graphics controller 1058. In one implementation, the I/O bus can include a super I/O (SIO) device.

PCI/PCIe devices can also be coupled to SB/ICH 1020 through a PCI bus 1062. The PCI devices may include, for example, Ethernet adapters, add-in cards, and PC cards for notebook computers. Further, the hard disk drive (HDD) 1060 and optical drive 1066 can also be coupled to the SB/ICH 1020 through a system bus. The Hard disk drive 1060 and the optical drive or CD-ROM 1066 can use, for example, an integrated drive electronics (IDE) or serial advanced technology attachment (SATA) interface.

In one implementation, a keyboard 1070, a mouse 1072, a serial port 1076, and a parallel port 1078 can be connected to the system bus 1080 through the I/O bus 1082. Other peripherals and devices that can be connected to the SB/ICH 1020 include a mass storage controller such as SATA or PATA (Parallel Advanced Technology Attachment), an Ethernet port, an ISA bus, a LPC bridge, SMBus, a DMA controller, and an Audio Codec (not shown).

In one implementation of CPU 1030, the instruction register 1138 retrieves instructions from the fast memory 1140. At least part of these instructions are fetched from the instruction register 1138 by the control logic 1136 and interpreted according to the instruction set architecture of the CPU 1030. Part of the instructions can also be directed to the register 1132. In one implementation, the instructions are decoded according to a hardwired method, and in another implementation, the instructions are decoded according a microprogram that translates instructions into sets of CPU configuration signals that are applied sequentially over multiple clock pulses. After fetching and decoding the instructions, the instructions are executed using the arithmetic logic unit (ALU) 1134 that loads values from the register 1132 and performs logical and mathematical operations on the loaded values according to the instructions. The results from these operations can be feedback into the register and/or stored in the fast memory 1140. According to certain implementations, the instruction set architecture of the CPU 1030 can use a reduced instruction set architecture, a complex instruction set architecture, a vector processor architecture, a very large instruction word architecture. Furthermore, the CPU 1030 can be based on the Von Neuman model or the Harvard model. The CPU 1030 can be a digital signal processor, an FPGA, an ASIC, a PLA, a PLD, or a CPLD. Further, the CPU 1030 can be an x86 processor by Intel or by AMD; an ARM processor, a Power architecture processor by, e.g., IBM; a SPARC architecture processor by Sun Microsystems or by Oracle; or other known CPU architecture.

The present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The functions and features described herein may also be executed by various distributed components of a system. For example, one or more processors may execute these system functions, wherein the processors are distributed across multiple components communicating in a network. The distributed components may include one or more client and server machines which may share processing in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

The hardware description above, exemplified by any one of the structure examples shown in FIG. 9 or 10, constitutes or includes specialized corresponding structure that is programmed or configured to perform the algorithm shown in FIG. 2.

A system that includes the features in the foregoing description provides numerous advantages to users. In particular, the system and associated methodology described herein provides an improvement to the field of crowdfunding and crowdsourcing. The method expedites project delivery by centralizing the process of crowdfunding and crowdsourcing. In addition, the system is capable of storing, computing, and analyzing a large amount of data to select a freelancer. Thus, a computer selected freelancer provides the advantage of expedited and better selection based on large amount of processing of data which could not be feasibly done by a human. In addition, generating and transmitting an alert to the freelancer's mobile device with time sensitive information and causing the alert to display on the freelancer's mobile device provide expedited results while minimizing errors. Thus, the system and associated methodology described herein amount to significantly more than an abstract idea based on the improvements and advantages described herein.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present invention is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

The above disclosure also encompasses the embodiments listed below.

(1) A method for crowdsourcing and crowdfunding a project, the method including: receiving, via communication circuitry, a project from a user; determining, using processing circuitry, whether the project adheres to a predetermined criteria; providing, via the communication circuitry, the project to a crowdsourcing community and a crowdfunding community when the project adheres to the predetermined criteria; receiving, via the communication circuitry, bids from one or more freelancers associated with the crowdsourcing community to implement one or more parts of the project; receiving, via the communication circuitry, contributions from one or more contributors associated with the crowdfunding community; selecting, using the processing circuitry, at least one freelancer based on a predefined rule; determining, using the processing circuitry, a total amount of contributions based on the received contributions from the one or more contributors; determining, using the processing circuitry, a total amount of funds needed based on a bid of the selected at least one freelancer; determining, using the processing circuitry, whether the total amount of contributions is at least equal to the total amount of funds needed; assigning, using the processing circuitry, the one or more parts of the project to the selected at least one freelancer when the total amount of contributions is a least equal to the total amount of funds needed; transmitting, via the communication circuitry, an alert to at least one device associated with the selected at least one freelancer, wherein the alert causes a message to display on the selected at least one freelancer device; and submitting, via the communication circuitry, payments to the selected at least one freelancer when the one or more corresponding parts associated with the selected at least one freelancer is approved.

(2) The method of (1), further including: generating a message to the crowdfunding community indicating the selected at least one freelancer; receiving votes from the crowdfunding community; analyzing the votes to determine whether the crowdfunding community approves of the selected at least one freelancer; and selecting another freelancer when the crowdfunding community does not approve of the at least one freelancer.

(3) The method of (1) or (2), wherein the predefined rule is a function of a plurality of factors.

(4) The method of (3), wherein the plurality of factors includes at least one of a bid amount, a rating, and a geographical location.

(5) The method of (3), wherein each of the plurality of factors has a predetermined weight.

(6) The method of (5), wherein the weight of each of the plurality of factors is a function of past ratings of completed projects.

(7) The method of (3), further including: calculating a rank as a function of the plurality of factors, wherein calculating the rank includes applying

$$Rank = {\sum }_{i = 1}^{n} {factor}_{i} \times {weight}_{i}$$

where n is the number of the plurality of factors.

(8) The method of any one of (1) to (7), further including: determining an average rating for a freelancer during a predetermined period.

(9) The method of any one of (1) to (8), further including: determining a funding limit for each of the contributors; and sending the project to contributors that did not exceed their funding limit.

(10) A system for freelancing and crowdfunding projects, including: communication circuitry; and processing circuitry configured to receive, via the communication circuitry, a project from a user, determine whether the project adheres to a predetermined criteria, provide, via the communication circuitry, the project to a crowdsourcing community and a crowdfunding community when the project adheres to the predetermined criteria, receive, via the communication circuitry, bids from one or more freelancers associated with the crowdsourcing community to implement one or more parts of the project, receive, via the communication circuitry, contributions from one or more contributors associated with the crowdfunding community, select at least one freelancer based on a predefined rule, determine a total amount of contributions based on the received contributions from the one or more contributors, determine a total amount of funds needed based on a bid of the selected at least one freelancer, determine whether the total amount of contributions is at least equal to the total amount of funds needed, assign the one or more parts of the project to the selected one or more freelancers when the total amount of contributions is a least equal to the total amount of funds needed, transmit, via the communication circuitry, an alert to at least one device associated with the selected at least one freelancer, wherein the alert causes a message to display on the selected at least one freelancer device and submit, via the communication circuitry, payments to the selected one or more freelancers when the one or more corresponding parts associated with the selected at least one freelancer is approved.

(11) The system of (10), wherein the processing circuitry is further configured to: generate a message to the crowdfunding community indicating the selected at least one freelancer; receive votes from the crowdfunding community; analyze the votes to determine whether the crowdfunding community approves of the selected at least one freelancer; and select another freelancer when the crowdfunding community does not approve of the at least one freelancer.

(12) The system of (10) or (11), wherein the predefined rule is a function of a plurality of factors.

(13) The system of (12), wherein the plurality of factors includes at least one of a bid amount, a rating, and a geographical location.

(14) The system of (12), wherein each of the plurality of factors has a predetermined weight.

(15) The system of (14), wherein the weight of each of the plurality of factors is a function of past ratings of completed projects.

(16) The system of (12), wherein the processing circuitry is further configured to: calculate a rank as a function of the plurality of factors, wherein calculating the rank includes applying

$$Rank = {\sum }_{i = 1}^{n} {factor}_{i} \times {weight}_{i}$$

where n is the number of the plurality of factors.

(17) The system of any one of (10) to (16), wherein the processing circuitry is further configured to: determine an average rating for a freelancer during a predetermined period.

(18) The system of any one of (10) to (17), wherein the processing circuitry is further configured to: determine a funding limit for each of the contributors; and send the project to contributors that did not exceed their funding limit.

(19) A non-transitory computer readable medium storing computer-readable instructions therein which when executed by a computer causes the computer to perform a method for crowdsourcing and crowdfunding a project, the method including: receiving a project from a user; determining whether the project adheres to a predetermined criteria; providing the project to a crowdsourcing community and a crowdfunding community when the project adheres to the predetermined criteria; receiving bids from one or more freelancers associated with the crowdsourcing community to implement one or more parts of the project; receiving contributions from one or more contributors associated with the crowdfunding community; selecting at least one freelancer based on a predefined rule; determining a total amount of contributions based on the received contributions from the one or more contributors; determining a total amount of funds needed based on a bid of the selected at least one freelancer; determining whether the total amount of contributions is at least equal to the total amount of funds needed; assigning the one or more parts of the project to the selected one or more freelancers when the total amount of contributions is a least equal to the total amount of funds needed; transmitting an alert to at least one device associated with the selected at least one freelancer, wherein the alert causes a message to display on the selected at least one freelancer device; and submitting payments to the selected one or more freelancers when the one or more corresponding parts associated with the selected at least one freelancer is approved.

(20) The non-transitory computer readable medium method of (19), wherein the method further includes: generating a message to the crowdfunding community indicating the selected at least one freelancer; receiving votes from the crowdfunding community; analyzing the votes to determine whether the crowdfunding community approves of the selected at least one freelancer; and selecting another freelancer when the crowdfunding community does not approve of the at least one freelancer.

(21) The non-transitory computer readable medium of (19) or (20), wherein the predefined rule is a function of a plurality of factors.

(22) The non-transitory computer readable medium of (21), wherein the plurality of factors includes at least one of a bid amount, a rating, and a geographical location.

(23) The non-transitory computer readable medium of (21), wherein each of the plurality of factors has a predetermined weight.

(24) The non-transitory computer readable medium of (23), wherein the weight of each of the plurality of factors is a function of past ratings of completed projects.

(25) The non-transitory computer readable medium of (21), wherein the method further includes: calculating a rank as a function of the plurality of factors, wherein calculating the rank includes applying

$$Rank = {\sum }_{i = 1}^{n} {factor}_{i} \times {weight}_{i}$$

where n is the number of the plurality of factors.

(26) The non-transitory computer readable medium of any one of (19) to (25), wherein the method further includes determining an average rating for a freelancer during a predetermined period.

(27) The non-transitory computer readable medium of any one of (19) to (26), wherein the method further includes determining a funding limit for each of the contributors; and sending the project to contributors that did not exceed their funding limit.

1. A method for crowdsourcing and crowdfunding a project, the method comprising:
receiving, via communication circuitry, a project from a user;
determining, using processing circuitry, whether the project adheres to a predetermined criteria;
providing, via the communication circuitry, the project to a crowdsourcing community and a crowdfunding community when the project adheres to the predetermined criteria;
receiving, via the communication circuitry, bids from one or more freelancers associated with the crowdsourcing community to implement one or more parts of the project;
receiving, via the communication circuitry, contributions from one or more contributors associated with the crowdfunding community;
selecting, using the processing circuitry, at least one freelancer based on a predefined rule;
determining, using the processing circuitry, a total amount of contributions based on the received contributions from the one or more contributors;
determining, using the processing circuitry, a total amount of funds needed based on a bid of the selected at least one freelancer;
determining, using the processing circuitry, whether the total amount of contributions is at least equal to the total amount of funds needed;
assigning, using the processing circuitry, the one or more parts of the project to the selected at least one freelancer when the total amount of contributions is a least equal to the total amount of funds needed;
transmitting, via the communication circuitry, an alert to at least one device associated with the selected at least one freelancer, wherein the alert causes a message to display on the selected at least one freelancer device; and
submitting, via the communication circuitry, payments to the selected at least one freelancer when the one or more corresponding parts associated with the selected at least one freelancer is approved.

2. The method of claim 1, further comprising:
generating a message to the crowdfunding community indicating the selected at least one freelancer;
receiving votes from the crowdfunding community;
analyzing the votes to determine whether the crowdfunding community approves of the selected at least one freelancer; and
selecting another freelancer when the crowdfunding community does not approve of the at least one freelancer.

3. The method of claim 1, wherein the predefined rule is a function of a plurality of factors.

4. The method of claim 3, wherein the plurality of factors includes at least one of a bid amount, a rating, and a geographical location.

5. The method of claim 3, wherein each of the plurality of factors has a predetermined weight.

6. The method of claim 5, wherein the weight of each of the plurality of factors is a function of past ratings of completed projects.

7. The method of claim 3, further comprising:
calculating a rank as a function of the plurality of factors, wherein calculating the rank includes applying
$$Rank = {\sum }_{i = 1}^{n} {factor}_{i} \times {weight}_{i}$$
where n is the number of the plurality of factors.

8. The method of claim 1, further comprising:
determining an average rating for a freelancer during a predetermined period.

9. The method of claim 1, further comprising:
determining a funding limit for each of the contributors; and
sending the project to contributors that did not exceed their funding limit.

10. A system for freelancing and crowdfunding projects, comprising:
communication circuitry; and
processing circuitry configured to
receive, via the communication circuitry, a project from a user,
determine whether the project adheres to a predetermined criteria,
provide, via the communication circuitry, the project to a crowdsourcing community and a crowdfunding community when the project adheres to the predetermined criteria,
receive, via the communication circuitry, bids from one or more freelancers associated with the crowdsourcing community to implement one or more parts of the project,
receive, via the communication circuitry, contributions from one or more contributors associated with the crowdfunding community,
select at least one freelancer based on a predefined vile,
determine a total amount of contributions based on the received contributions from the one or more contributors,
determine a total amount of funds needed based on a bid of the selected at least one freelancer,
determine whether the total amount of contributions is at least equal to the total amount of funds needed,
assign the one or more parts of the project to the selected one or more freelancers when the total amount of contributions is a least equal to the total amount of funds needed,
transmit, via the communication circuitry, an alert to at least one device associated with the selected at least one freelancer, wherein the alert causes a message to display on the selected at least one freelancer device, and
submit, via the communication circuitry, payments to the selected one or more freelancers when the one or more corresponding parts associated with the selected at least one freelancer is approved.

11. The system of claim 10, wherein the processing circuitry is further configured to:
generate a message to the crowdfunding community indicating the selected at least one freelancer;
receive votes from the crowdfunding community;
analyze the votes to determine whether the crowdfunding community approves of the selected at least one freelancer; and
select another freelancer when the crowdfunding community does not approve of the at least one freelancer.

12. The system of claim 10, wherein the predefined rule is a function of a plurality of factors.

13. The system of claim 12, wherein the plurality of factors includes at least one of a bid amount, a rating, and a geographical location.

14. The system of claim 12, wherein each of the plurality of factors has a predetermined weight.

15. The system of claim 14, wherein the weight of each of the plurality of factors is a function of past ratings of completed projects.

16. The system of claim 12, wherein the processing circuitry is further configured to:
calculate a rank as a function of the plurality of factors, wherein calculating the rank includes applying
$$Rank = {\sum }_{i = 1}^{n} {factor}_{i} \times {weight}_{i}$$
where n is the number of the plurality of factors.

17. The system of claim 10, wherein the processing circuitry is further configured to:
determine an average rating for a freelancer during a predetermined period.

18. The system of claim 10, wherein the processing circuitry is further configured to:
determine a funding limit for each of the contributors; and
send the project to contributors that did not exceed their funding limit.

19. A non-transitory computer readable medium storing computer-readable instructions therein which when executed by a computer causes the computer to perform a method for crowdsourcing and crowdfunding a project, the method comprising:
receiving a project from a user;
determining whether the project adheres to a predetermined criteria;
providing the project to a crowdsourcing community and a crowdfunding community when the project adheres to the predetermined criteria;
receiving bids from one or more freelancers associated with the crowdsourcing community to implement one or more parts of the project;
receiving contributions from one or more contributors associated with the crowdfunding community;
selecting at least one freelancer based on a predefined rule;
determining a total amount of contributions based on the received contributions from the one or more contributors;
determining a total amount of funds needed based on a bid of the selected at least one freelancer;
determining whether the total amount of contributions is at least equal to the total amount of funds needed;
assigning the one or more parts of the project to the selected one or more freelancers when the total amount of contributions is a least equal to the total amount of funds needed;
transmitting an alert to at least one device associated with the selected at least one freelancer, wherein the alert causes a message to display on the selected at least one freelancer device; and
submitting payments to the selected one or more freelancers when the one or more corresponding parts associated with the selected at least one freelancer is approved.

20. The non-transitory computer readable medium of claim 19, wherein the method further comprises:
generating a message to the crowdfunding community indicating the selected at least one freelancer;
receiving votes from the crowdfunding community;
analyzing the votes to determine whether the crowdfunding community approves of the selected at least one freelancer; and
selecting another freelancer when the crowdfunding community does not approve of the at least one freelancer.
